(19) United States
(12) Patent Application Publication
(10) Pub. No.: US 2023/0114270 A1
(43) Pub. Date: Apr. 13, 2023

(54) IMAGE EDITING

(71) Applicant: Hewlett-Packard Development Company, L.P., Spring, TX (US)

(72) Inventors: Rowdy K Webb, Vancouver, WA (US); Barret Kammerzell, Vancouver, WA (US)

(21) Appl. No.: 17/907,307

(22) PCT Filed: Apr. 23, 2020
(86) PCT No.: PCT/US2020/029476

§ 371 Date: Sep. 26, 2022

(51) Int. Cl. G06F 3/04845; G06T 11/60; G06F 3/04883

(52) U.S. Cl. CPC G06F 3/04845; G06F 3/04883; G06T 11/60

(57) ABSTRACT

Example implementations relate to image editing. Some examples include a non-transitory machine-readable medium containing instructions executable by a processor to cause the processor to receive input via a display of a computing device indicating a primary region of an image on which to focus image editing, convert the received input to metadata associated with the image, and communicate the metadata and the image to an editor for editing based on the metadata.

### BACKGROUND

Image editing can include processes of altering images, including digital photographs, photo-chemical photographs, or illustrations. Analog image editing can include using tools such as an airbrush to modify photographs or editing illustrations with an art medium. Editing programs, such as vector graphics editors, raster graphics editors, and three-dimensional (3D) modelers, can be used to manipulate, enhance, and/or transform digital or analog images.

### BRIEF DESCRIPTION OF THE DRAWINGS

FIG. 1 illustrates a system for image editing according to an example;

FIG. 2 illustrates a diagram of a controller including a processor, a memory resource, and instructions according to an example;

FIG. 3 illustrates a method for image editing according to an example; and

FIG. 4 illustrates communication of an image and associated metadata to an editor for editing according to an example.

### DETAILED DESCRIPTION

Image editing can include storing raster images on a device in the form of a grid of picture elements called pixels. These pixels include the image’s color and brightness information. An editor (e.g., automated, manual) can change the pixels to enhance the image, for instance, by changing the pixels as a group, or individually, using models within automated image editors or other image editing tools. Image editing can also include the use of vector graphic models to create and modify vector images for modification during image editing. Other image editing techniques may be used herein and examples of the present disclosure are not so limited.

Image editing, whether a manual edit-as-a-service or automated edits using programs and/or applications, may not allow for discerning of an intent of an image. For instance, it may be unknown what aspects of the image are important to a user or what elements a user desires to be focal points of the image. This can result in edits that do not meet the expectation of a user.

Some approaches to image editing include verbal or written communication sent with an image describing the intent of the image. This can be time-consuming for the user and the editor, and automated editing programs may not correctly comprehend verbal or written communication.

In contrast, examples of the present disclosure provide for image editing in which a user can provide input (e.g., via a digital pen, finger, mouse, etc.) to indicate primary and secondary regions of interest in an image. The indicators can be sent as a visual description and carried with the image as metadata. When presented to an editor, either manual or physical, the metadata can be used to guide the image editing. For instance, a primary region may gain prominence in composition, exposure, sharpening, etc., while the secondary region may be kept within a cropped area without prominence in other editing techniques. This can improve quality of the edit by clarifying which portions of the image are focal points for the user. Other input may be provided with the image in some examples to improve editing.

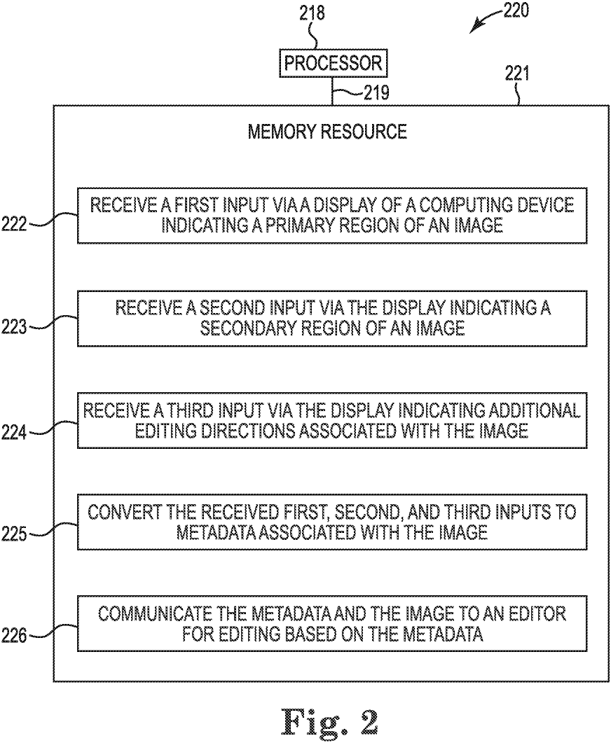

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Multiple analogous elements within one figure may be referenced with a reference numeral followed by a hyphen and another numeral or a letter. For example, 466-1 may reference element 66-1 in FIG. 4 and 466-2 may reference element 66-2, which can be analogous to element 66-1. Such analogous elements may be generally referenced without the hyphen and extra numeral or letter. For example, elements 466-1 and 466-2 may be generally referenced as 450.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. As used herein, the designator “m”, “n”, “p”, “q”, and “s” particularly with respect to reference numerals in the drawings, indicates that a number of the particular feature so designated can be included with examples of the present disclosure. The designators can represent the same or different numbers of the particular features.

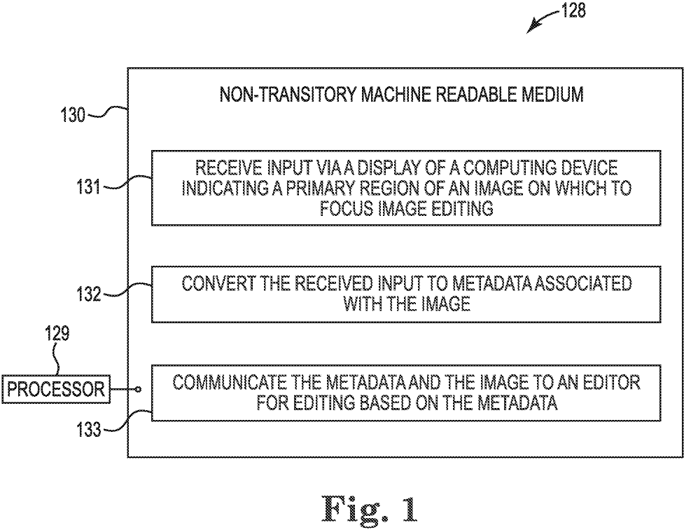

FIG. 1 illustrates a system for image editing according to an example. System 128 can be a computing device in some examples and can include a processor 129. System 128 can further include a non-transitory machine-readable medium (MRM) 130, on which may be stored instructions, such as instructions 131, 132, and 133. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

Non-transitory MRM 130 may be electronic, magnetic, optical, or other physical storage device that stores executable instructions. Thus, non-transitory MRM 130 may be, for example, Random Access Memory (RAM), an Electrically-Erasable Programmable ROM (EEPROM), a storage drive, an optical disc, and the like on-transitory MRM 130 may be disposed within system 128, as shown in FIG. 1. In this example, the executable instructions 131, 132, and 133 can be “installed” on the device. Additionally and/or alternatively, non-transitory MRM 130 can be a portable, external or remote storage medium, for example, that allows system 128 to download the instructions 131, 132, and 133 from the portable/external/remote storage medium. In this situation, the executable instructions may be part of an “installation package”. In some examples, the instructions 131, 132, and 133 be performed in real time. As described herein, non-transitory MRM 130 can be encoded with executable instructions for image editing.

Instructions 131, when executed by a processor such as processor 129, can include instructions to receive input via a display of a computing device indicating a primary region of an image on which to focus image editing. The input can be received via an application, website, or other workflow. In some examples, the input can be received as a touch gesture via a touchscreen display of the computing device. When a touchscreen display is touched by a finger, digital pen (e.g., stylus), or other input mechanism, associated data can be received by the computing device. The touchscreen display may include pictures and/or words, among others that a user can touch to interact with the device. In some examples, the display may be a non-touchscreen display, and the input can be received via a mouse or keyboard.

The input can include a user indicating the primary region by drawing a shape (e.g., circle, oval, square, etc.) around a region of the image on which to focus image editing. For instance, a user may want a particular person in the image to be the focus can draw a shape around the entire person or a portion of the person (e.g., face) to indicate the primary region. The drawing, for instance, can include the user using his or her finger, a digital pen, a mouse, a shape tool of the computing device, or a combination thereof to indicate the primary region. In some instances, a solid line may be an indicator of a primary region.

In some examples, additional input can be received form the user indicating a secondary region of the image for contextual use during image editing. For instance, a user may use a dotted line when drawing a shape around a portion of the image considered part of a secondary region. A user may choose particular text, people, or other portions of the image the user indicates is less of a focus than the primary region or regions. For instance, a user may choose a road sign in an image as being part of a secondary region, while the person standing elsewhere in the image is part of a primary region.

In some instances, additional input from the user can be received indicating a region of the image to remove during image editing. For example, the user may use his or her finger, a digital pen, a mouse, a shape or eraser tool of the computing device, or a combination thereof to indicate the region to be removed. In some instances, an “x” may be drawn over a region to be removed. For example, a user may desire to remove a person from an image that was in the frame of the image but is unknown to the user.

In some examples, additional input may be received from the user. Example additional input, as will be discussed further herein, includes written communication indicating a primary region, secondary region, or other region, as well as particulars about edits (e.g., warmer, color correction, sharper, etc.). The additional input, in some examples, can include an option chosen from predetermined options. For instance, a user may choose, “color correct image” from a drop-down menu when submitting the image for editing.

Instructions 132, when executed by a processor such as processor 129, can include instructions to convert the received input to metadata associated with the image. As used herein, metadata includes data that describes and gives information about other data. For instance, the shapes, line types, text, options, and/or a combination thereof can be converted to data that describes and gives information about the chosen primary, secondary, and additional regions particular to the associated image. The metadata can summarize information about the received user input, which can be used in editing the image.

Instructions 134, when executed by a processor such as processor 129, can include instructions to communicate the metadata and the image to an editor for editing based on the metadata. The editor, whether manual or automated, can use the associated metadata to edit the image. Manual editing, in some examples, includes a person editing the image, while automated editing can include a program having editing tools editing the image. In some instances, the editing can be a combination of manual and automated editors.

In some examples, an edited version may not include regions indicated for deletion but may include enhanced primary regions. A primary region may include color correction, image sharpening, corrected exposure, adjusted white balance, etc., while a secondary region may be saved from an image crop. Written communication and option inputs can be considered in the editing process, in some examples. For example, a user may communicate “soften entire image” via written communication, which an editor can implement during editing.

In some instances, an edited image can be returned. For instance, an edited version of the image that underwent a manual edit based on the metadata or edited version of the image that underwent an automated edit based on the metadata can be received from the editor. The image can be returned to the user, sent to a printing device, sent to an image book creator, or other option chosen by the user.

FIG. 2 illustrates a diagram of a controller 220 including a processor 218, a memory resource 221, and instructions 222, 223, 224, 225, and 226 according to an example. For instance, the controller 220 can be a combination of hardware and instructions for image editing. The hardware, for example can include a processor 218 and/or a memory resource 221 (e.g., MRM, computer-readable medium (CRM), data store, etc.).

The processor 218, as used herein, can include a number of processing resources capable of executing instructions stored by a memory resource 221. The instructions (e.g., machine-readable instructions (MRI)) can include instructions stored on the memory resource 221 and executable by the processor 218 to implement a desired function (e.g., image editing). The memory resource 221, as used herein, can include a number of memory components capable of storing non-transitory instructions 222, 223, 224, 225, and 226 that can be executed by processor 218. Memory resource 221 can be integrated in a single device or distributed across multiple devices. Further, memory resource 221 can be fully or partially integrated in the same device as processor 218 or it can be separate but accessible to that device and processor 218. Thus, it is noted that the controller 220 can be implemented on an electronic device and/or a collection of electronic devices, among other possibilities.

The memory resource 221 can be in communication with the processor 218 via a communication link (e.g., path) 219. The communication link 219 can be local or remote to an electronic device associated with the processor 218. The memory resource 221 includes instructions 222, 223, 224, 225, and 226. The memory resource 221 can include more or less instructions than illustrated to perform the various functions described herein. The instructions 222, 223, and 224 (e.g., software, firmware, etc.) can be downloaded and stored in the memory resource 221 (e.g., MRM) as well as a hard-wired program (e.g., logic), among other possibilities.

Instructions 222, when executed by a processor such as processor 218, can include instructions to receive a first input via a display of a computing device indicating a primary region of an image and instructions 223, when executed by a processor such as processor 218, can include instructions to receive a second input via the display indicating a secondary region of an image. The primary region can be associated with a subject of the image and the secondary region can be associated with context of the image. For instance, an image may include a person outside a theme park entrance. A user may indicate the person is in the primary region of the image by circling the person’s face with a solid line (e.g., using a touch gesture on a touchscreen display). The user may indicate a sign at the theme park entrance is in the secondary region of the image by making a dotted line square around the sign indicating the sign is contextually relevant to the image, but it is not the focus of the image.

Instructions 224, when executed by a processor such as processor 218, can include instructions to receive a third input via the display indicating additional editing directions associated with the image. For instance, the third input can include written instructions from a user, an option chosen from a plurality of predetermined option, a region of the image to remove in editing, or a combination thereof. For instance, in the theme park example, a user may communicate in a textual manner that he or she would like the person to be color corrected, and that a bystander in the image be cropped out in editing. Alternatively or additionally, the user may choose “sharpen” from a drop-down menu (or other menu-type) to indicate he or she would like the image as a whole sharpened. The drop-down menu can reduce ambiguities, particularly with respect to automated editors, as the editor may have instructions for responding to each predetermined option. In some examples, a user may indicate an area to be removed from the image, for instance, by marking the area with an “x”. For instance, a user my “x” a car that may be unwanted in the image for removal in editing.

Instructions 225, when executed by a processor such as processor 218, can include instructions to convert the received first, second, and third inputs to metadata associated with the image. For instance, the shapes, line types, written communication (e.g., text), options, deletions, and/or a combination thereof can be converted to metadata that describes and gives information about the chosen primary, secondary, and additional regions particular to the associated image. The metadata can summarize information about the received user input and can be used in editing the image.

Instructions 226, when executed by a processor such as processor 218, can include instructions to communicate the metadata and the image to an editor for editing based on the metadata. The editor, whether manual or automated, can use the associated metadata to edit the image. For instance, an edited version may not include regions indicated for deletion but may include enhanced primary regions. A primary region may include color correction, image sharpening, corrected exposure, adjusted white balance, etc., while a secondary region may be saved from an image crop. Written communication and option inputs can be considered in the editing process, in some examples.

In some examples, the edited version of the image includes a hierarchy of edits based on the metadata. For instance, editing may occur based on a hierarchy that prioritizes primary regions followed by secondary regions. The hierarchy may then include regions for deletion, written instructions, and/or options chosen from predetermined lists of options. In some examples, if editing associated with a lower level in the hierarchy interferes with editing associated with a higher level, the lower level editing may not occur. For instance, in the theme park example, if the car cannot be removed without negatively affecting editing of the person in the primary region, the car may not be removed.

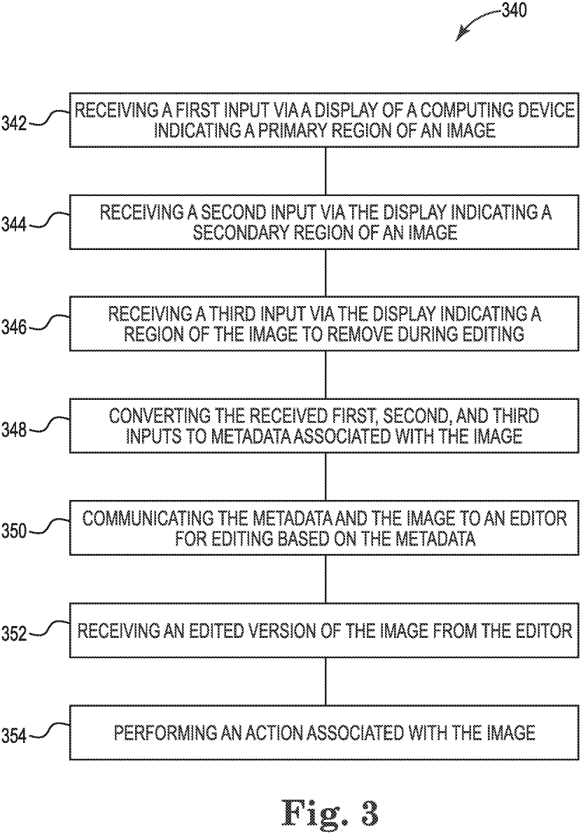

FIG. 3 illustrates a method for image editing according to an example. The method 340 may be performed by a system 128 and/or controller 220 as described with respect to FIGS. 1 and 2. At 342, the method 340 includes receiving a first input via a display of a computing device indicating a primary region of an image and at 344, the method 340 includes receiving a second input via the display indicating a secondary region of an image. At 346, the method 340 includes receiving a third input via the display indicating a region of the image to remove during editing. Receiving the first, the second, and the third inputs can include receiving a different touch gesture input via a touchscreen display for each of the first, the second, and the third inputs and/or input from a mouse, for instance, via a display (touchscreen or other). The primary region can be associated with a subject of the image and the secondary region is associated with context of the image. Input associated with the primary region can include a solid line (or other indicator) around a region a user deems a focus of the image, such as a particular person, animal, landmark, etc. Input associated with the secondary region can include a dotted line (or another indicator different than that of the primary region) around a region the user deems contextual. For instance, a user may want particular text or landscape to remain in the image (e.g., avoid cropping) to give context of the image, but may not desire extra editing such as color correction or sharpening in that secondary region. Input associated with a region to remove during editing may be an eraser tool, “x” mark, or another indicator different than the those associated with the primary and the second regions. For instance, a user may indicate a stranger in an image or a stain on a shirt are desired to be removed from an image in editing.

In some examples, additional input including written communication from the user and/or options chosen by a user from a predetermined list can be received as input. This additional input can be associated with the primary region, secondary region, region of the image to be removed, other region, overall image, or a combination thereof. For example, a user may use written instructions to describe a specific crop, color correction, or overall sharpening of the image, among other possible written instructions. Similar, a user may choose, “black and white”, and “image softening” from a predetermined list of editing options that an automated editor may be prepared to comprehend.

At 348, the method 340 includes converting the received first, second, and third inputs to metadata associated with the image. In some instances, the additional input can also be converted to metadata associated with the image. For instance, the shapes, line types, written instructions, options, deletions, and/or a combination thereof can be converted to metadata that describes and gives information about the chosen primary, secondary, and additional regions particular to the associated image. The metadata can summarize information about the received user input and can be used in editing the image.

At 350, the method 340 includes communicating the metadata and the image to an editor for editing based on the metadata, and at 352, the method 340 includes receiving an edited version of the image from the editor. The editor, whether automated or manual, can used the metadata associated with the image to make changes to the image that are in line with the user’s requests and preferences. After implementing the edits, the image can be returned as an edited version of the image/

At 354, the method 340 includes performing an action associated with the image. In some examples, performing the action can include requesting review of the edited version of the image from the user. For instance, it may be desired for the user to review and approve or deny the edits. The user may be able to submit additional input via touch gestures, choosing options from predetermined lists, and/or written communication if the user denies the edits. The new additional input can be converted to metadata and communicated to the editor as previously described for additional editing.

In some examples, performing the action can include sending the edited version of image to a printing device. For example, a user may request printing of the image subsequent to the editing (e.g., with or without additional review from the user). In some examples, a user may choose to have an image gift (e.g., photograph book, photograph greeting card, image canvas, etc.) created subsequent to the editing (e.g., with or without additional review from the user), such that performing the image includes creating a product using the edited version of the image.

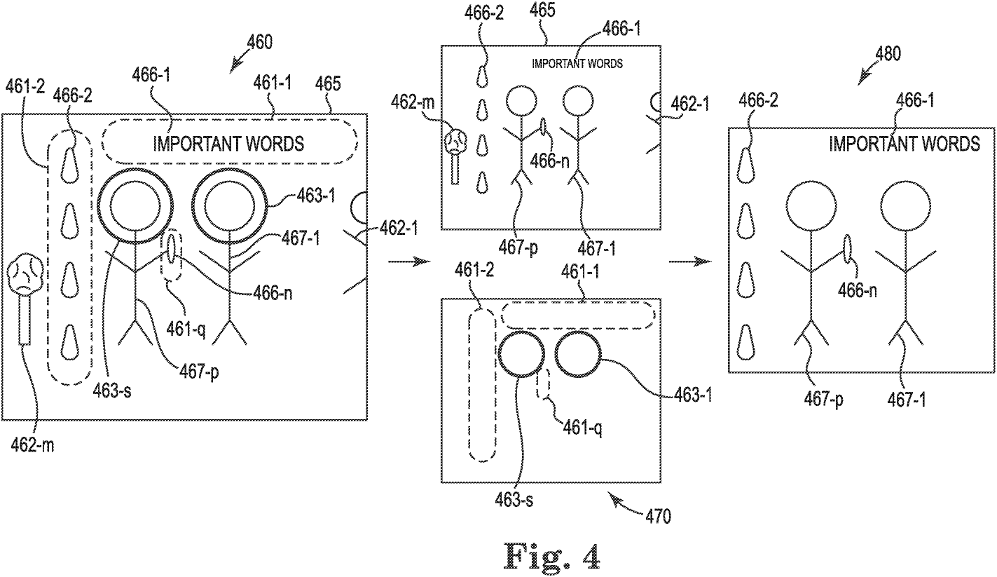

FIG. 4 illustrates communication of an image 465 and associated metadata 470 to an editor for editing according to an example. Box 460 illustrates an image 465 including input from a user regarding particular regions of the image 465. For instance, the user has indicated (e.g., via touch gesture or other input at a display of a computing device) that the faces of person 467-1 and person 467-q as primary regions of the image 465 by using solid circles 463-1 and 463-s to highlight those regions. The user has indicated that the text “IMPORTANT WORDS” 466-1, the droplets 466-2, and the object 461-p are as secondary regions of the image 465 by using dotted ovals 461-1, 461-2, and 466-1q. Person 462-1 and tree 462-m do not include region indicators, and their fate may be left to the editor. Though not illustrated in FIG. 4, regions to be removed from the image may be indicated by the user. For instance, person 462-1 and/or tree 462-m may be indicated as a region to be removed by putting an “x” over the person 462-1 or the tree 462-m. Different numbers of primary regions, secondary regions, regions to be removed, and/or other inputs may be possible.

The inputs 461 and 463 can be converted to metadata 470 and communicated with the image 465 to an editor. For instance, the image 465 including people 467, text 466-1, object 466-n, person 462-1, droplets 466-2, and tree 462-m can be communicated to the editor with the metadata 470 (e.g., “sandwiched together”) or separated from the metadata 470 that includes the primary region indicators 463 and the secondary region indicators 461. In addition, written communication and/or other options chosen by a user from a predetermined list of editing options may be sent to the editor as metadata 470 along with the image 465 in some examples.

An edited version 480 of the image 465 can include manual edits or edits performed by an automated editor. For instance, in the example illustrated in FIG. 4, the faces of people 467, which were indicated to be primary regions, may be enhanced through editing such that it is clear they are the focus of the edited version 480. Enhancement can include, for instance, color correcting, blur correction, sharpening or softening, exposure correction, white balance correction, red-eye reduction, favorable cropping, or a combination thereof, among other editing enhancements.

Elements 466, which were indicated to be secondary regions remain in the edited version 480, such that they are not cropped from the image 465. In some examples, elements 466, as part of a secondary region, may be marginalized (e.g., near an edge of a crop) such that they remain in the image 465, but are not a focus. The elements 466 may or may not receive additional editing from the editor. The elements 462, which were not indicated to be part of a particular region by the user are cropped out in the example illustrated in FIG. 4. For instance, the editor may determine that the elements 462 do not contribute to the image 465 and may crop them, such that the elements 462 are not a part of the edited version 480. Additional metadata that came from written communication and/or chosen options may be implemented by the editor into the edited version 480, in some examples.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A non-transitory machine-readable medium containing instructions executable by a processor to cause the processor to:
receive input via a display of a computing device indicating a primary region of an image on which to focus image editing;
convert the received input to metadata associated with the image; and
communicate the metadata and the image to an editor for editing based on the metadata.

2. The medium of claim 1, further comprising the instructions executable to receive additional input from the user indicating a secondary region of the image for contextual use during image editing.

3. The medium of claim 1, further comprising the instructions executable to receive additional input from the user indicating a region of the image to remove during image editing.

4. The medium of claim 1, further comprising the instructions executable to receive an edited version of the image from the editor that underwent an automated edit based on the metadata.

5. The medium of claim 1, further comprising the instructions executable to receive an edited version of the image from the editor that underwent a manual edit based on the metadata.

6. The medium of claim 1, further comprising instructions executable to receive the input as a touch gesture via a touchscreen display of the computing device.

7. A controller comprising a processor in communication with a memory resource including instructions executable to:
receive a first input via a display of a computing device indicating a primary region of an image;
receive a second input via the display indicating a secondary region of an image;
wherein the primary region is associated with a subject of the image and the secondary region is associated with context of the image;
receive a third input via the display indicating additional editing directions associated with the image;
convert the received first, second, and third inputs to metadata associated with the image; and
communicate the metadata and the image to an editor for editing based on the metadata.

8. The controller of claim 7, further comprising the instructions executable to receive input from the user via the display indicating a region of the image to remove in editing.

9. The controller of claim 7, wherein the third input comprises written instructions from a user.

10. The controller of claim 7, wherein the third input comprises an option chosen from a plurality of predetermined options.

11. The controller of claim 7, further comprising the instructions executable to receive an edited version of the image from the editor including a hierarchy of edits based on the metadata.

12. A method, comprising:
receiving a first input via a display of a computing device indicating a primary region of an image;
receiving a second input via the display indicating a secondary region of an image;
wherein the primary region is associated with a subject of the image and the secondary region is associated with context of the image;
receiving a third input via the display indicating a region of the image to remove during editing;
converting the received first, second, and third inputs to metadata associated with the image;
communicating the metadata and the image to an editor for editing based on the metadata;
receiving an edited version of the image from the editor; and
performing an action associated with the image.

13. The method of claim 12, wherein performing the action comprises sending the edited version of the image to a printing device.

14. The method of claim 12, wherein performing the action comprises requesting review of the edited version of the image from the user.

15. The method of claim 12, wherein receiving the first, the second, and the third inputs comprises receiving a different touch gesture input via a touchscreen display for each of the first, the second, and the third inputs.
